(19) United States
(12) Patent Application Publication
(10) Pub. No.: US 2006/0111948 A1
(43) Pub. Date: May 25, 2006

(54) Verbal ordering system

(75) Inventor: Raul Kivatinetz, Los Angeles, CA (US)

Correspondence Address: CISLO & THOMAS, LLP, 233 WILSHIRE BLVD, SUITE 900, SANTA MONICA, CA, 90401-1211, US

(73) Assignee: AssistMed, Inc.

(21) Appl. No.: 11/287,185

(22) Filed: Nov. 22, 2005

Related U.S. Application Data
(60) Provisional application No. 60/630,219, filed on Nov. 23, 2004.

(51) Int. Cl. G06Q 40/00

(52) U.S. Cl. 705/4

(57) ABSTRACT

A verbal physician ordering system authenticates identity of the physician and enables caregivers and physicians to coordinate their activities in treating patients. Such authentication is realized electronically by telephone, datalink password and/or PIN, voice print authorization, or otherwise. In this way, the physician can exercise medical authority remotely, have the physician's instructions executed by the caregiver, and have the appropriate logging functions for treatment instructions executed. In conjunction with a telephone or other audio/visual exchange as well as a web server, text-to-speech conversion server, and authentication server, caregivers can make inquiry and doctors can effect patient treatment in a coordinated fashion. Caregivers can propose treatments and the system ensures that licensed physicians only make the medical decisions regarding patient treatment. Alternatively, such doctors can initiate such treatment and have it administered by the caregiver. Using text-to-speech conversion, specific treatments or remedies can be selected by GUI and then played back to the doctor for approval, disapproval, or modification.

### CROSS-REFERENCES TO RELATED APPLICATIONS

This patent application is related to and claims priority from U.S. Provisional Patent Application Ser. No. 60/630,219 filed Nov. 23, 2004 entitled Verbal Ordering System which application is incorporated herein by this reference thereto.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

The present invention relates to computerized authorization systems for use where an authorizing signature is required.

2. Description of the Related Art

When treatment needs to be administered to patients in hospitals, nursing homes, etc., a physician/doctor must be called for authorization. This frequently results in, on an average, of 3 calls per patient per day. The responsible physician gives the order to a health care professional, usually by telephone. The on site professional must then write the order into the patient's medical record. However, rules for accreditation currently in effect require that the physician authorizing the treatment must manually sign each order.

There are computerized physician ordering entry systems (CPOE) that are available in the market today which are primarily designed for in-house orders. These systems require that the physician sign, albeit electronically, after the fact, all verbal orders which were given on the floor or over the telephone.

Most physicians frequently fail to comply with the signature requirement. As a result, the healthcare institutions must dedicate staff to contact the physicians and obtain their signatures so that the institution is in compliance with regulations.

Consequently, there is a need in the art in order to provide better coordination between caregivers and doctors who may be geographically separated and yet focused on a single patient treatment or the treatment of many patients at once each one having a variety of medical conditions requiring oversight by a physician. However, prior attempts may not have fully implemented possible labor and time-saving options that enable patient treatment although the doctor is not there personally to administer such medical treatment to the patient him or herself.

### SUMMARY OF THE INVENTION

In view of the foregoing disadvantages inherent in the known types of systems for coordinated caregiver and physician operation in the treatment of patients now present in the prior art, the present system and method provides a new means by which caregiver and physician activities can be coordinated wherein patient treatment can be effected and better records can be kept of physician activity and decisions in conjunction with caregiver assistance.

The general purpose of the present invention, described greater detail below is to provide better patient care through the coordination of caregiver and physician activity generally segregating the decision-making process of the physician from the treatment provided by the caregiver even though such treatment is physician authorized which is not anticipated, rendered obvious, suggested, taught, or even implied by any of the prior art physician-caregiver systems, either alone or in any combination thereof.

According to the present invention, one or multiple database(s) (DB) contain lists of potential procedures, tests, drugs, equipment and other products and services to be administered or supplied to in-patients who are hospitalized in healthcare institutions of any type or to out-patients in any ambulatory healthcare facility. A graphical user interface (GUI) allows the selection of one or multiple items contained in the database(s) from almost all, if not all, electronic or other communication systems, including stationary and/or mobile computerized and/or telephonic systems or devices. A conference calling system, including a telephone or voice-over-internet conference calling system (TCS) and/or an interactive voice response (IVR) system, integrates with the available databases. A text-to-voice converting program (TTV) or a text-to-speech conversion program (TTS) is employed so that items in a database (such as the ones mentioned above, or otherwise) can be transmitted as voice or speech messages over the calling system.

A healthcare professional can select a desired and/or proposed treatment or other protocol, prescription, or equipment recommendation and by using the calling and verbal ordering system as set forth herein, an authorizing physician can hear the proposed treatment or other protocol, prescription, or equipment recommendation as a verbal communication.

After hearing the proposed treatment, protocol, prescription, or equipment, the authorizing physician can discuss the matter with the on site professional and either authorize the orders through the use of an authorizing code or can discuss other options and authorize them after the orders have been selected and verbally repeated to the physician by the system's text-to-speech technology.

The system can be used in multiple fashions, as follows:

a) The person or caregiver administering care, or dispensing products, or providing services to the patient accesses the DB either by the GUI, TCS, or IVR and selects items from the DB and identifies the medical professional (doctor) who must authorize the orders. The system then initiates a conference call and contacts the doctor as by telephonic conference, computerized messaging system, or otherwise. The doctor connects to the conference call in real time, via the GUI to the verbal physician order entry (VPOE) system of the present invention, or otherwise and identifies himself as by a secure system such as voice-print authentication (VPA), user ID, biometric identification system, or otherwise and listens to the requested orders played by the system's TTV/TTS. The doctor can either approve the orders as by the GUI, telephone keypad, or otherwise or can conduct a conference call via the TCS/IVR (or otherwise) with the caregiver to discuss and/or modify and add to the orders. Both the doctor and the caregiver can modify the orders through the GUI at any time during the process. Once the doctor approves the orders, the VPOE requests him to sign by entering his private code on the telephone keypad or GUI.

b) Alternatively, the caregiver can call or connect to the TCS/IVR and confer with the doctor, who can listen to the orders played by the system's TTV/TTS, discuss them with the caregiver and then approve and sign them by entering his private code on the telephone keypad or GUI. Other secure authorization and/or signature means may be used to ensure that the medical authority of the doctor is not abused or subject to fraud.

The VPOE keeps a detailed log of all the transactions and it time stamps them for proper auditing and reporting. The VPOE can interface to other systems to receive patient demographics and clinical data (such as drug contraindications, etc.) as well as transfer the items included in the orders for other related processes to other systems.

Accordingly, it is an object of the invention to provide a system that can provide remote authorization for treatment by a physician or other responsible health care provider as well as making the necessary and/or recommended updates to a patient's records at the patient's or other location.

It is another object of the invention to permit a telephonic conference among a physician, an on-site care giver, and a database to select and authorize a treatment or protocol that satisfies the authorization requirements.

The novel features which are characteristic of the invention, both as to structure and method of operation thereof, together with further objects and advantages thereof, will be understood from the following description, considered in connection with the accompanying drawing, in which the preferred embodiment of the invention is illustrated by way of example. It is to be expressly understood, however, that the drawings are for the purpose of illustration and description only, and are not intended as a definition of the limits of the invention.

In one embodiment, a system for providing documented patient care and treatment includes a database of treatments and procedures for administration to a patient. An interface provides access to the database and enables selection of an element within the database. A conference calling system coupled to the database and a text-to-speech conversion system coupled to the conference calling system provides some voice capability. In this way and in conjunction with the foregoing system, a first person can select one or more proposed treatments and/or one or more proposed procedures for a patient to create a proposed treatment set having one or more elements and a second person who is authorized to approve the individual elements of the treatment set can be informed of the individual elements by the conference calling system and the text-to-speech conversion system and can approve or disapprove individually each separate one of the individual elements.

In another embodiment of the present invention, a method for providing documented care and treatment for a patient includes the step of providing a database of treatments and procedures for administration to the patient. Other steps include providing an interface providing access to the database and selection of an element with the database, receiving a selection of a proposed treatment or procedure via the interface, establishing contact with a physician via a conference calling system coupled to the database, and transmitting the selection of a proposed treatment to the physician via a text-to-speech conversion system coupled to the conference calling system. Through this method, a first person can select one or more proposed treatments and/or one or more proposed procedures for a patient to create a proposed treatment set having one or more elements and the physician who is authorized to approve the individual elements of the treatment set can be informed of the individual elements by the conference calling system and the text-to-speech conversion system and can approve or disapprove individually each separate one of the individual elements.

### BRIEF DESCRIPTION OF THE DRAWINGS

FIG. 1 is a block diagram representing the elements and their general lines of interaction of the system of the present invention.

FIGS. 2-8 are flow charts showing in a coordinating fashion one embodiment of the present invention for both caregiver and doctor implementation and use of the present system.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The terms “physician” and “doctor” are used interchangeably herein.

The present invention resides in communication systems for physicians and caregivers using pre-recorded orders corresponding to entries for treatment access via a graphics user interface or otherwise by either the caregiver or the physician, or both. As many treatments and remedies are known in advance and can be listed, the caregiver may need to request permission from a physician before effecting treatment or remedy of a patient. By selecting such treatment and then implementing the system to contact the physician, the caregiver can quickly recommend proposed treatments and get a doctor's decision either contemporaneously with the proposals or later if such treatment could be delayed. The doctor may indicate decisions by a secure means in order to prevent abuse and fraud and may enjoy the conveniences of telephonic or otherwise communication by updating contact information for the doctor with the systems so that the caregiver and the physician may always be in touch on an appropriate basis.

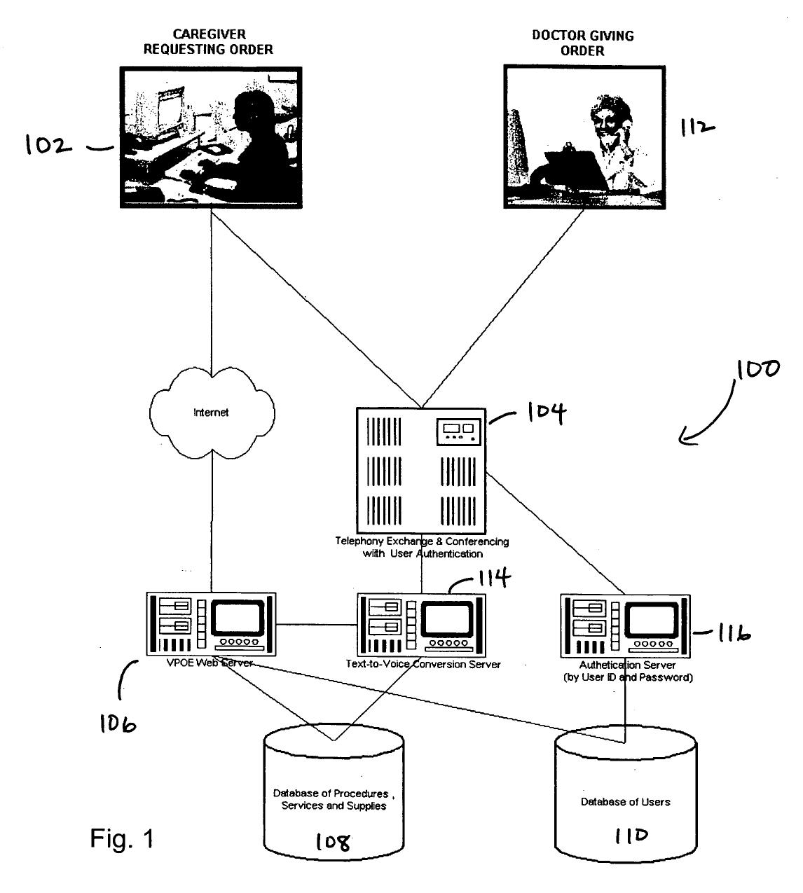

Referring to the drawings, where like numerals of reference designate like elements throughout, it will be noted that in FIG. 1, a Verbal Physician Order Entry System 100, according to the present invention is shown in block diagrammatic form. A caregiver 102 is linked to a telephone exchange 104 and, through a data link, to a web server 106 that communicates with a treatment database 108 and a user database 110. A physician 112 who must authorize treatment is also linked to the telephone exchange 104.

The treatment database 108 is also connected to a text-to-voice/text-to-speech (TTV/TTS) conversion device 114 which provides, in a vocal, verbal format, each of the treatment options stored in the database 108. The audio transmission of treatment options and otherwise may arise from audio signals created contemporaneously with the transmission of same. Such audio transmission could arise from pre-recording of text files converted to audio files when the system has available processing resources. Also, audio files could be created prior to storing them in the treatment database 108 in conjunction or not with any related text files stored in the database 108. Audio transmission of the treatment options provides a vocal, verbal feedback of any selected treatment option from the database 108. The text-to-speech conversion device 114 applies its output to the telephone exchange 104.

An authenticating server 116 is connected to the user database 110 as a security element to limit access to known users who have properly identified themselves. Potential users of the treatment database 108 must be recognized and authenticated before being granted access. Accordingly both the care giver and the physicians must be recognized by the system.

In operation, a care giver 102 decides upon a course of treatment for a patient. Such a course of treatment must be authorized by a treating physician 112. The care giver 102 accesses the system by supplying identification information to the user database 110 which is authenticated by the authentication server 116. The care giver 102 is then permitted to access the treatment database 108 and selects one or more procedures or medications. The treating physician 112 is then called by the telephone exchange 104 and the care giver 102 proposes the course of treatment, which is accessed from the treatment database 108 and which is verbally repeated from the text-to-speech conversion device 114.

If the treating physician 112 concurs, an authorization is transmitted to the care giver 102 and is entered on the medical record in lieu of a manuscript signature.

It is also possible that the treating physician 112 can initiate the procedure by accessing the system, obtaining authorization and selecting a medication or treatment from the treatment database 108 and having that medication or treatment communicated to the health care provider 102 who would receive both a verbal direction and a transmitted data direction to the medical record, together with the necessary authorization.

In either event, the care giver 102 and the physician 112 could confer and select treatment options from the database 108 which, when agreed upon, would be repeated, verbally by the text-to-speech converter 114, and then digitally entered into the medical record with the physician's authorization.

In other fields in which an authorizing signature must be verified and affixed to a document or record, a similar system can be employed using the user database and the other elements. In a situation requiring an authorizing signature, the person whose signature is required is contacted, the substance of the matter to be authorized is communicated and, using any of the interfaces, the person can confirm the affixation of his signature as evidence of authorization.

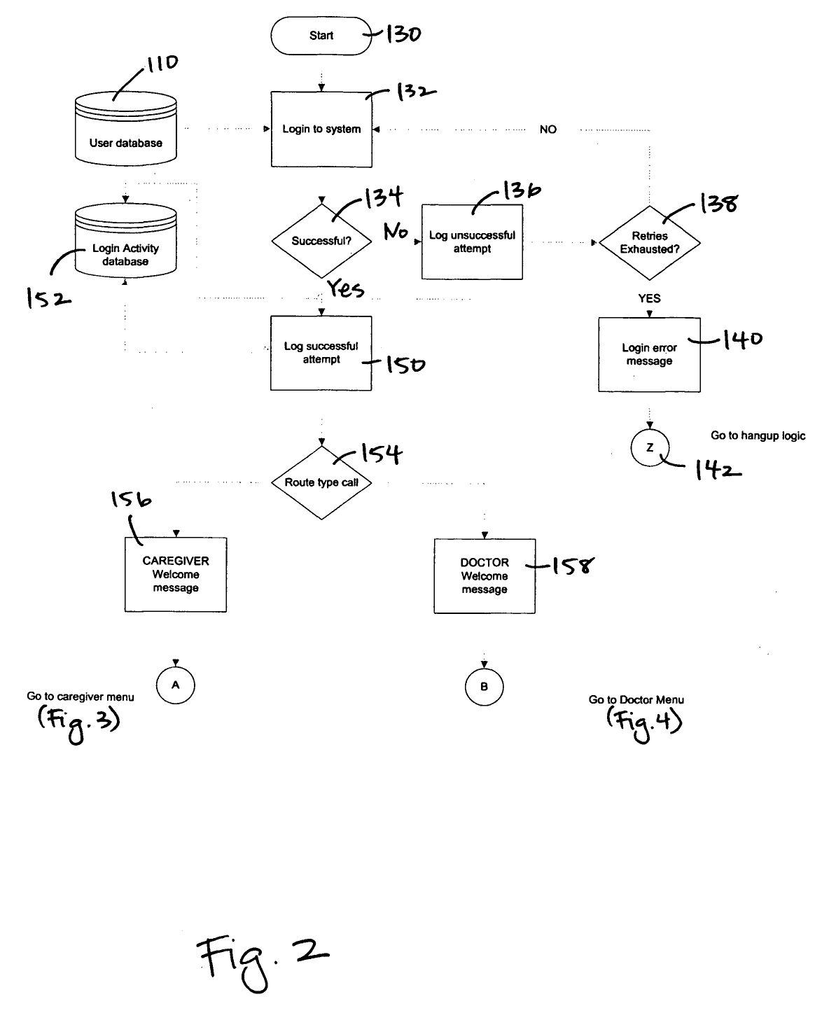

The method and several of its distinctive steps is shown in one embodiment in the accompanying FIGS. 2-8. Due to the extensive nature of the method, nodes are used in order to show transfer of control flow from one diagram to the other. These nodes do not necessarily actually exist in the method but are used as a continuity device to ensure that the steps, events, or actions are taken in the sequence indicated.

In FIG. 2, the Verbal Physician Ordering System of the present invention is initiated 130 either by the caregiver or the doctors indicated above. A login sequence is then initiated 132 which generally engaged the user database 110 in order to ensure authenticated login and access to the system resources and the login is tested for authenticity 134. If the login is not successful, a record is made of the unsuccessful attempt in a log or journal 136. Query is made to as to whether or not the number of retries has been exhausted 138 as such retries 138 have been exhausted a login error message is generated and transmitted 140 and the session is ended 142 as by hanging up the phone or otherwise disconnecting the inquiry from further recognition by the system. If the number of retries has not been exhausted, control is returned to the “login system” step 132 and query 134 is yet again made once the credentials (often a user name and password) have been submitted by the user initiating 130 the process.

If the login attempt is successful, the successful log attempt is logged 150 and as for the unsuccessful attempt login 136 both are logged in a database of login activities 152. The login activity database 132 allowed system administrators and authorized others to review the activity at the outset of initiation of the program. Generally, this enables the recognition at the early stage of the frequent and numerous attempts, mischievous individuals, or rogue programs might use in attempting to gain access to the system 100. Upon logging the successful attempt, determination is made as to the type of call 154 that has been made to the system. If the call is a caregiver call, a caregiver welcome message 156 is transmitted with control and resuming through node A. If the call is from a doctor, a doctor's welcome message is transmitted 158 and process control is then continued through node B.

When a doctor logs in the VPOE the system may execute a Voice Print Authentication (“VPA”) process. VPA requires enrollment by voice for all doctors during set up before they can start using the VPOE. This confirms identity of the physician. During enrollment, the system will request a PIN (personal identification number) or a user ID. Additionally, the system may maintain a list of telephone numbers authorized by the doctor. It may be mandatory that the PIN plus one of the other two, VPA or authorized telephone number, are validated. If this can not be done, the system may send notification to the doctor via email, SMS, or other method so he can sign electronically online all orders for which the VPOE could not validate the identity of the doctor.

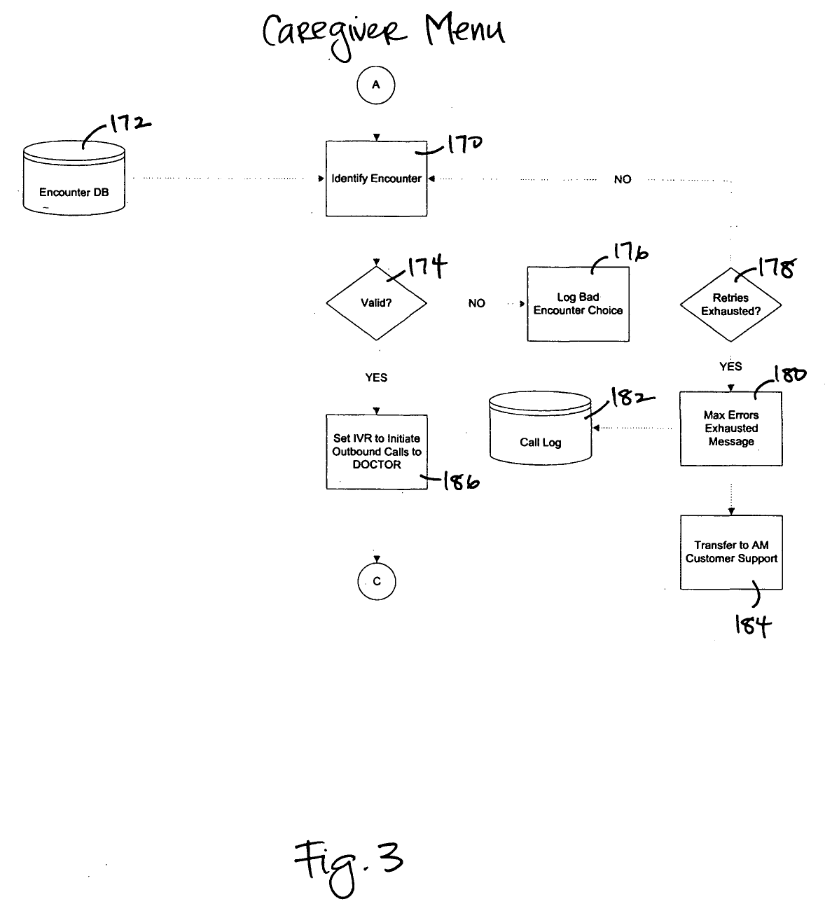

FIG. 3 shows the continuation of the process via node A.

Once the caregiver welcome message 156 of FIG. 2 has been transmitted to the user, an encounter is then identified 170 in conjunction with an encounter database 172. A query 174 is then made as to the validity of the encounter. If the encounter is invalid, a login tree is made with respect to the bad encounter choice 176. Query is then made as to whether or not the number of allowed retries to identify a valid encounter 178 is made. If the number of retries has been exhausted 178 a maximum errors exhausted message 180 is transmitted in conjunction with a call log 182. Transfer is then made to Customer Support 184.

If the encounter is validated at the inquiry step 174 the IVR (interactive voice response system) is set.

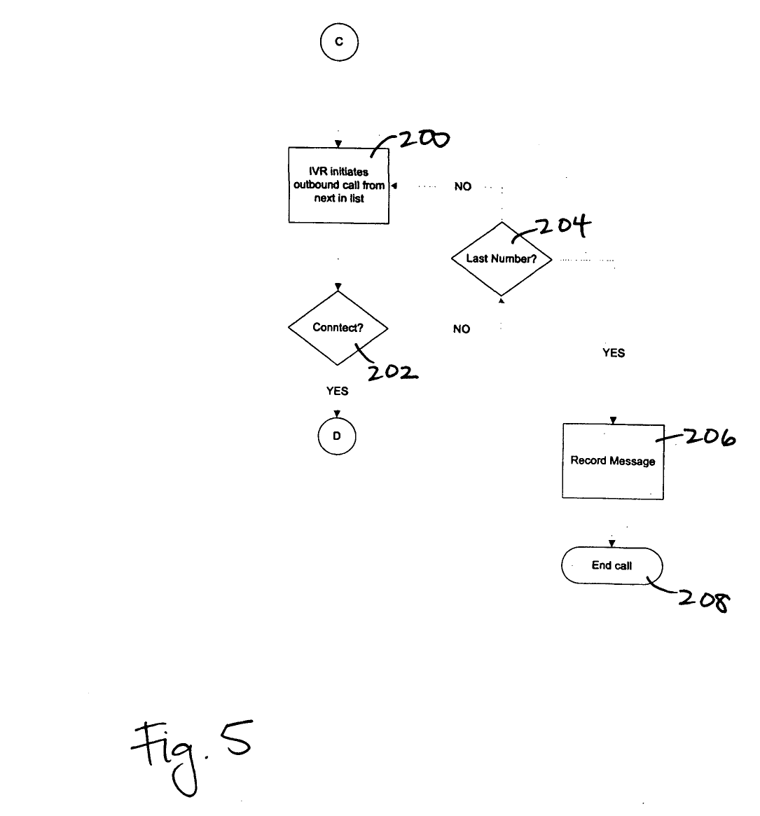

To initiate one or more outbound calls to the doctor 186 transfer of the process is then made to node C (FIG. 5).

In FIG. 5, upon setting the IVR to initiate the outbound call(s) to the doctor 186 the IVR then initiates the outbound call from the next entry in a call list 200 inquiry is then made as to the connection of the call 202. If the call has not connected, inquiry is made as to whether it is the last number on the list 204. If it is not the last number, control is then returned back to the IVR initiation step where the outbound call is made for the next number in the call list 200. If the number at the inquiry step 204 regarding the last number is indeed the last number, a message is recorded 206 indicating the same and then the call ends 208.

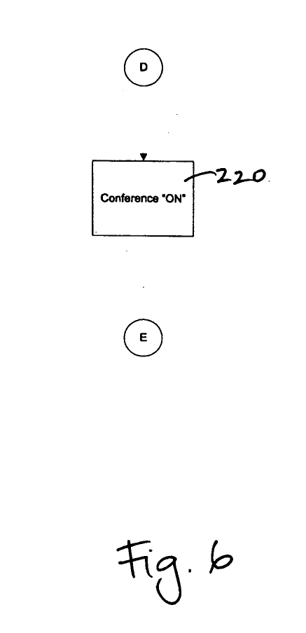

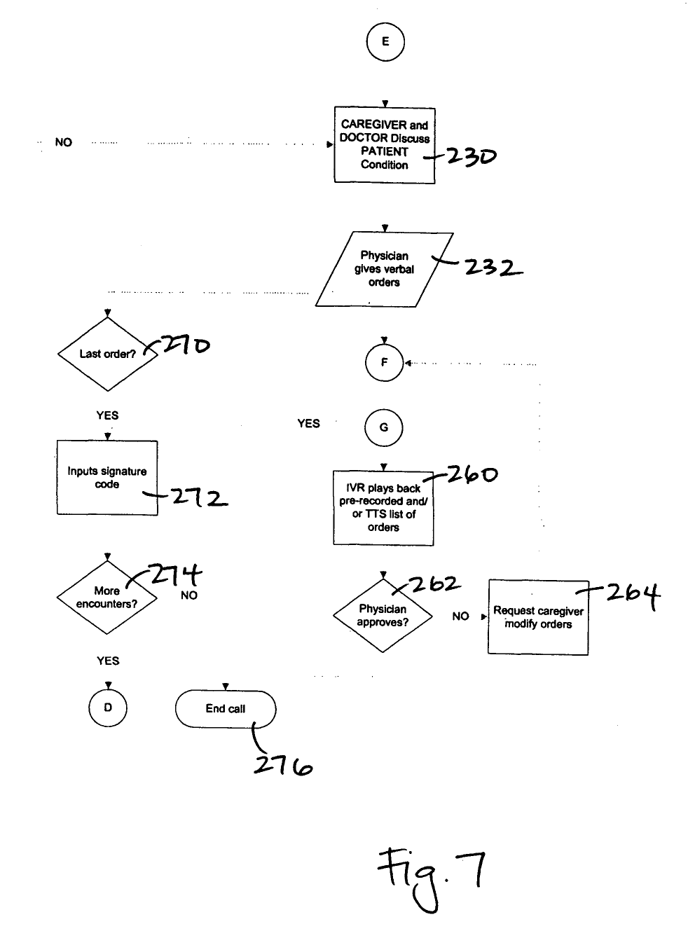

Alternatively, at the connection inquiry 202 if a connection is established, then transfer of control flow is then made to node D (FIG. 6) where a conference is then initiated 220. Transfers that are made to node E (FIG. 7).

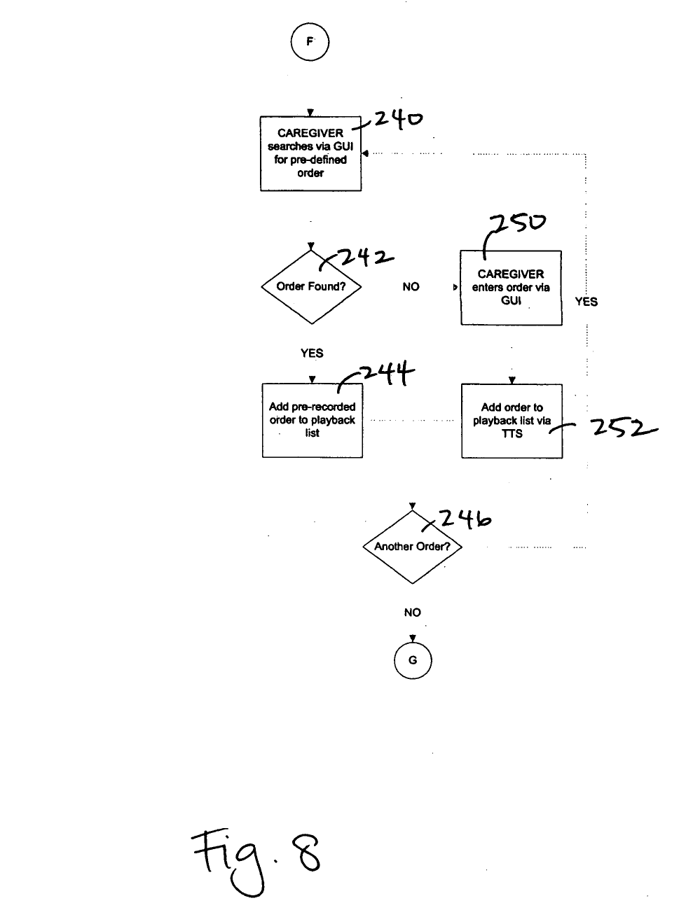

In FIG. 7, once the conference has been initiated 220 the caregiver and doctor discuss the patient's condition or other relevant factors going into the proposed treatment 230. And so discussing the patient condition 230, the physician then makes or authorizes treatment by delivering verbal orders 232 and control is then transferred to node F (FIG. 8).

Once the physician has given the verbal orders, the caregiver searches via the GUI or other interface communication device for a predefined order 240. The GUI or otherwise that accesses the VPOE web server 106 via the internet or otherwise the predefined order may be one that is set forth in a structured or other database in the database of procedures, services, and supplies 108. If the order is found at the relevant inquiry step 242 a pre-recorded order voice, audio, or other transmission is added to the playback list 244. Inquiry is then made as to whether or not there is another order 246 that should be made. If there is not another order 246, program or method flow control is then transferred to node G (FIG. 7).

If there is another order 246, flow control is then transferred to the step where the caregiver searches via the GUI or otherwise for a predefined order 240. Such a predefined order may be searched as by text search or subject matter or otherwise. Database structures now known or later developed may be used in conjunction with such searching. Recently, Google™ has implemented a search utility for PC desktops and is known in the art for providing relevant database searching tools that are generally readily available over the internet or otherwise as by license.

Returning to the step where inquiry made as to whether or not the order is found 242, if no order is found, the caregiver may then enter the order via the GUI or otherwise 250. Then the order is added to the playback list via text-to-speech system (TTS) 252.

After adding the order to the playback list via TTS 252 inquiry is to made as to whether or not there is another order 256. Process then proceeds as previously described or if there is another order, the caregiver then searches via the GUI step 240 or, if there is not another order, flow control is transferred to node G (FIG. 7).

Returning now to FIG. 7, at node G, the IVR plays back the pre-recorded and/or TTS list (Please describe TTS) list of orders 260. Inquiry is then made as to whether or not the physician approves of the order or orders played back to the doctor.

If the physician does not approve of the order, request is made to the caregiver to modify the order or orders 264 and flow control is then transferred to node F (FIG. 8) which is described in detail above.

If the physician does approve of the order or orders 262, inquiry is made as to whether or not the order just approved by the physician is the last order 270. If the order is not the last order, flow control is then delivered to step 230 and progress is then made through as described above and as indicated in FIG. 7.

If the last order inquiry 270 is the last order, the doctor then inputs the signature code 272 and an inquiry is made as to whether there are any more encounters. If there are not more encounters, the call ends 276, otherwise the flow control is transferred to node D (FIG. 6) which has been described above.

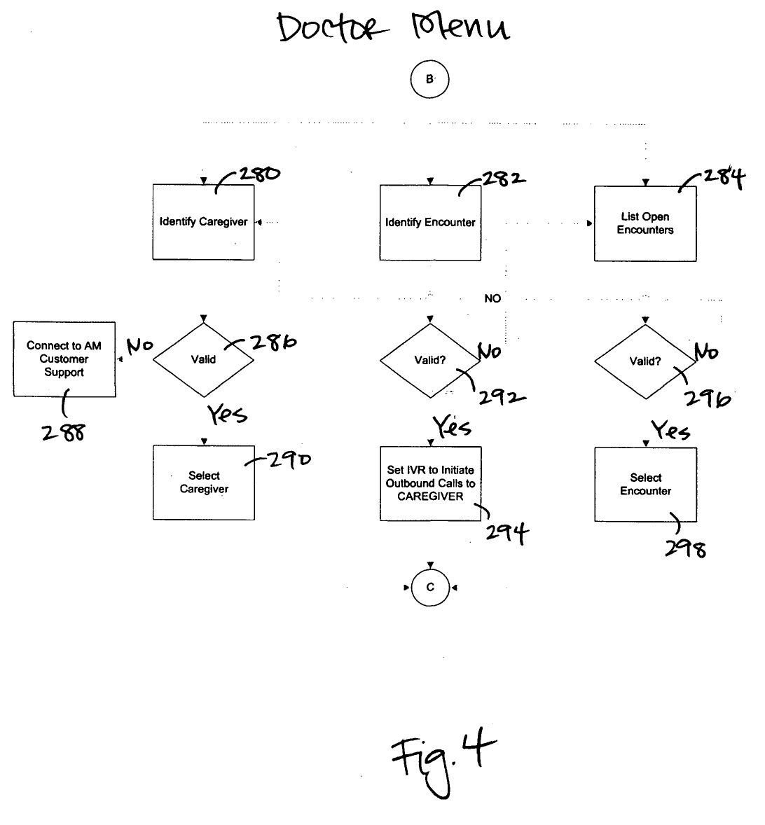

Having described above the steps taken by the method set forth herein with respect to the caregiver welcome message and the steps taken of the method through node A (FIG. 2) if the inquiry of the type of call and its routing 154 (FIG. 2) is for a doctor welcome message 158, then flow control is then transferred to node B (FIG. 4).

While node A generally carries the process into the caregiver menu, node B generally carries the process into the doctor menu. The doctor may be presented with three options including identifying the caregiver 280, identifying the encounter 282, and/or listing the open encounters 284. If the doctor identifies the caregiver 280, inquiry is made as to the validity of the identified caregiver 286.

If the validity of the caregiver is not valid, the doctor may be connected to customer support 288 much in the manner of the caregiver menu at step 184. If the caregiver identified is valid at inquiry 286, the caregiver is selected 290, and control of the process is transferred to node C (FIG. 5) as described above.

If the doctor selects to identify the encounter 282 instead of identifying the caregiver 280, the encounter is checked to make sure it is valid as by inquiry 292. If the encounter is one that is not valid, control is then transferred to the list of open encounters step 284 identified above and described in more detail below.

If the encounter identified is valid, the IVR is set to initiate outbound calls to the relevant or appropriate caregiver 294.

Process control is then transferred to node C (FIG. 5) described in more detail above.

If the doctor selects the list of open encounters 284 any encounter selected by the doctor in that listing and selection step 284 is queried as to its validity 296. Generally, this may be a redundant step as only those valid encounters may be presented as open ones for listing in the list for open encounters step 284. However, as a check to ensure that no invalid encounters are selected by the doctor, the validity of any selected encounter from the list of open encounters step 284 may be made as by the selected encounter inquiry 296.

Alternatively, if the encounter selected by the physician at the list 284 is valid, the encounter is selected 298 and process control is then turned over to node C (FIG. 5) which is described in more detail above.

Between the structural architecture and informational transfer shown in FIG. 1 (where the physician 112 may also be connected to the internet and the VPOE webserver 106, and the structure flow control shown by the flow diagrams and charts of FIGS. 2-8, the present invention enables doctors to remotely treat patients in the hands of reliable, knowledgeable, and appropriate caregivers who can administrate treatment although caregivers are not authorized to initiate or make such decisions regarding, treatment. Much like a pharmacist can recommend over the counter remedies to customers, the pharmacist prescribe restricted chemicals are drugs such as those that are scheduled by the U.S. Federal Government, regulated by the FDA or otherwise.

By enabling caregivers to act in the doctor's stead of the physical administrations of remedies and treatments to patients, the doctor may be liberated or freed up to treat more patients, use his medical knowledge for a greater number of patients, and/or spend less time in so treating such patients. This provides advantages to patients, to the caregivers, and to the doctors and is generally facilitated by the development of communication technologies that have occurred over the past twenty years.

Indeed, it may be very possible to conduct the conference call as by voice over IP (VOIP) technology that may include video cameras or the like. As such, the caregiver may be able to deliver real time video information to the doctor so that he or she can make a relevant decision and/or discuss possible treatment options with the patient by a video conference or otherwise.

While the present invention has been described with regards to particular embodiments, it is recognized that additional variations of the present invention may be devised without departing from the inventive concept.

For example, if the doctor has a telephone that accepts data messages, the list of orders selected by the caregiver can be transmitted simultaneously as a data message even as the VPOE system reads them back. The doctor can then e-sign on his telephone by a code and such e-signature may be transmitted back to the database.

Additionally, if the doctor has a PDA (personal digital assistant) phone or is otherwise wirelessly connected to the VPOE system (via LAN or WAN) such that the doctor can accept data messages, the doctor can receive a proposed or other order set per above and e-sign any authorizations as well.

In at least some embodiments of the present invention, the signature code selected by each user can be coupled with PKI (public key infrastructure) certificates stored in a central database in order to add another layer of validation to the identity of the user(s), including both doctors and caregivers). Such PKI authentication may be required for endorsement by Joint Commissions or other agencies around the world.

What is claimed is:

1. A system for providing documented patient care and treatment, comprising:
a database of treatments and procedures for administration to a patient;
an interface providing access to said database and selection of an element with said database;
a conference calling system coupled to said database; and
a text-to-speech conversion system coupled to said conference calling system, whereby
a first person can select one or more proposed treatments and/or one or more proposed procedures for a patient to create a proposed treatment set lo having one or more elements and a second person who is authorized to approve the individual elements of said treatment set can be informed of said individual elements by said conference calling system and said text-to-speech conversion system and can approve or disapprove individually each separate one of said individual elements.

2. A system for providing documented patient care and treatment as set forth in claim 1, wherein said database of treatments and procedures further comprises:
a database of established treatments and procedures that have generally been standardized for patient therapy.

3. A system for providing documented patient care and treatment as set forth in claim 1, wherein said database of treatments and procedures further comprises:
said database of treatments and procedures transmitting audio signals of entries in said database.

4. A system for providing documented patient care and treatment as set forth in claim 3, wherein said database of treatments and procedures further comprises:
said database of treatments and procedures transmitting audio signals of entries in said database by means selected from the group consisting of pre-stored audio files, pre-recorded audio files, spontaneous conversion of text files to audio signals, and any combination of these.

5. A system for providing documented patient care and treatment as set forth in claim 1, wherein said interface further comprises:
an interface selected from the group consisting of: graphic user interfaces (GUIs), voice-based interfaces, and combinations thereof.

6. A system for providing documented patient care and treatment as set forth in claim 5, wherein said interface further comprises:
A graphical user interface allowing selection of one or more items contained in said database from stationary and/or mobile computerized and/or telephonic systems or devices.

7. A system for providing documented patient care and treatment as set forth in claim 5, wherein said conference calling system further comprises:
a conference calling system selected from the group consisting of: telephone conference calling systems, voice-over-internet conference calling systems, interactive voice response systems, and combinations thereof.

8. A system for providing documented patient care and treatment as set forth in claim 1, wherein said text-to-speech conversion system further comprises:
a text-to-speech conversion program enabling transmission of items in said database as voice messages over said conference calling system.

9. A system for providing documented patient care and treatment as set forth in claim 1, further comprising:
said first person being healthcare professional selecting a desired treatment or other protocol, prescription, or equipment recommendation from said database; and
said second person being an authorizing physician who hears said desired treatment or other protocol, prescription, or equipment recommendation as a verbal communication via said conference calling system.

10. A system for providing documented patient care and treatment as set forth in claim 1, further comprising:
said first and second person being the same person.

11. A system for providing documented patient care and treatment as set forth in claim 1, further comprising:
a database of users authorized to access the system, said user database coupled to said treatments database.

12. A system for providing documented patient care and treatment as set forth in claim 11, further comprising:
a web server coupled to a computer network, said web server providing said interface;
a text-to-speech conversion server coupled to said web server, said text-to-speech conversion server providing said text-to-speech conversion system; and
an authentication server coupled to said conference calling system and said user database, said authentication server authenticating users of the system.

13. A system for providing documented patient care and treatment as set forth in claim 12, further comprising:
said authentication server authenticating a user by voice-print authentication.

14. A system for providing documented patient care and treatment as set forth in claim 13, further comprising:
said authentication server further authenticating said user by a second key.

15. A system for providing documented patient care and treatment as set forth in claim 14, wherein said second key further comprises:
a second key selected from the group consisting of: a PIN (personal identification number), a user ID, and a combination of these.

16. A system for providing documented patient care and treatment as set forth in claim 12, further comprising:
a telephony exchange and conferencing system having user authentication capacity coupled to said text-to-speech conversion server, said telephony exchange providing said conference calling system.

17. A system for providing documented patient care and treatment, comprising:
a database of treatments and procedures for administration to a patient including a database of established treatments and procedures that have generally been standardized for patient therapy;
a database of users authorized to access the system, said user database coupled to said treatments database;
a web server coupled to a computer network, said web server providing an interface providing access to said treatments database and selection of an element with said database, said interface selected from the group consisting of: graphic user interfaces (GUIs), voice-based interfaces, and combinations thereof;
said user interface allowing selection of one or more items contained in said database from stationary and/or mobile computerized and/or telephonic systems or devices;
a telephony exchange and conferencing system having user authentication capacity, said telephony exchange providing a conference calling system coupled to said treatments database, said conference calling system selected from the group consisting of: telephone conference calling systems, voice-over-internet conference calling systems, interactive voice response systems, and combinations thereof;
a text-to-speech conversion server coupled to said web server, said text-to-speech conversion server providing a text-to-speech conversion system, said text-to-speech conversion system coupled to said conference calling system, said text-to-speech conversion program enabling transmission of items in said database as voice messages over said conference calling system;
said database of treatments and procedures transmitting audio signals of entries in said database by means selected from the group consisting of pre-stored audio files, pre-recorded audio files, spontaneous conversion of text files to audio signals, and any combination of these;
an authentication server coupled to said conference calling system and said user database, said authentication server authenticating a user by voice-print authentication and by a second key selected from the group consisting of: a PIN (personal identification number), a user ID, and a combination of these; whereby
a first person can select one or more proposed treatments and/or one or more proposed procedures for a patient to create a proposed treatment set having one or more elements and a second person who is authorized to approve the individual elements of said treatment set can be informed of said individual elements by said conference calling system and said text-to-speech conversion system and can approve or disapprove individually each separate one of said individual elements.

18. A system for providing documented patient care and treatment as set forth in claim 17, further comprising:
said first person being healthcare professional selecting a desired treatment or other protocol, prescription, or equipment recommendation from said database; and
said second person being an authorizing physician who hears said desired treatment or other protocol, prescription, or equipment recommendation as a verbal communication via said conference calling system.

19. A system for providing documented patient care and treatment as set forth in claim 17, further comprising:
said first and second person being the same person.

20. A method for providing documented care and treatment for a patient, comprising:
providing a database of treatments and procedures for administration to the patient;
providing an interface providing access to said database and selection of an element with said database;
receiving a selection of a proposed treatment or procedure via said interface;
establishing contact with a physician via a conference calling system coupled to said database; and
transmitting said selection of a proposed treatment to said physician via a text-to-speech conversion system coupled to said conference calling system; whereby
a first person can select one or more proposed treatments and/or one or more proposed procedures for a patient to create a proposed treatment set having one or more elements and said physician who is authorized to approve the individual elements of said treatment set can be informed of said individual elements by said conference calling system and said text-to-speech conversion system and can approve or disapprove individually each separate one of said individual elements.

21. A method for providing documented care and treatment for a patient as set forth in claim 20, wherein said database of treatments and procedures further comprises:
a database of established treatments and procedures that have generally been standardized for patient therapy.

22. A system for providing documented patient care and treatment as set forth in claim 20, further comprising:
transmitting audio signals of entries in said database of treatments and procedures.

23. A system for providing documented patient care and treatment as set forth in claim 20, further comprising:
transmitting audio signals of entries in said database of treatments and procedures by means selected from the group consisting of pre-stored audio files, pre-recorded audio files, spontaneous conversion of text files to audio signals, and any combination of these.

24. A method for providing documented patient care and treatment as set forth in claim 20, wherein said interface further comprises:
an interface selected from the group consisting of: graphic user interfaces (GUIs), voice-based interfaces, and combinations thereof.

25. A method for providing documented patient care and treatment as set forth in claim 24, wherein said interface further comprises:
A graphical user interface allowing selection of one or more items contained in said database from stationary and/or mobile computerized and/or telephonic systems or devices.

26. A method for providing documented patient care and treatment as set forth in claim 24, wherein said conference calling system further comprises:
a conference calling system selected from the group consisting of: telephone conference calling systems, voice-over-internet conference calling systems, interactive voice response systems, and combinations thereof.

27. A method for providing documented patient care and treatment as set forth in claim 20, wherein said text-to-speech conversion system further comprises:
a text-to-speech conversion program enabling transmission of items in said database as voice messages over said conference calling system.

28. A method for providing documented patient care and treatment as set forth in claim 20, further comprising:
said first person being healthcare professional selecting a desired treatment or other protocol, prescription, or equipment recommendation from said database.

29. A method for providing documented patient care and treatment as set forth in claim 20, further comprising:
said first person and said physician being the same person.

30. A method for providing documented patient care and treatment as set forth in claim 20, further comprising:
authenticating users by providing a database of users authorized to access the system, said user database coupled to said treatments database.

31. A method for providing documented patient care and treatment as set forth in claim 30, further comprising:
providing a web server coupled to a computer network, said web server providing said interface;
providing a text-to-speech conversion server coupled to said web server, said text-to-speech conversion server providing said text-to-speech conversion system; and
providing an authentication server coupled to said conference calling system and said user database, said authentication server authenticating users of the system.

32. A system for providing documented patient care and treatment as set forth in claim 31, further comprising:
said authentication server authenticating a user by voice-print authentication.

33. A system for providing documented patient care and treatment as set forth in claim 32, further comprising:
said authentication server further authenticating said user by a second key.

34. A system for providing documented patient care and treatment as set forth in claim 33, wherein said second key further comprises:
a second key selected from the group consisting of: a PIN (personal identification number), a user ID, and a combination of these.

35. A method for providing documented patient care and treatment as set forth in claim 31, further comprising:
providing a telephony exchange and conferencing system having user authentication capacity coupled to said text-to-speech conversion server, said telephony exchange providing said conference calling system.

36. A method for providing documented care and treatment for a patient, comprising:
providing a database of treatments and procedures for administration to the patient, said treatments database including a database of established treatments and procedures that have generally been standardized for patient therapy;
providing a web server adapted to be coupled to a computer network, said web server providing an interface providing access to said database and selection of an element with said database, said interface selected from the group consisting of: graphic user interfaces (GUIs), voice-based interfaces, and combinations thereof and including a graphical user interface allowing selection of one or more items contained in said database from stationary and/or mobile computerized and/or telephonic systems or devices;
receiving a selection of a proposed treatment or procedure via said interface;
establishing contact with a physician via a conference calling system coupled to said database, said conference calling system selected from the group consisting of: telephone conference calling systems, voice-over-internet conference calling systems, interactive voice response systems, and combinations thereof;
transmitting said selection of a proposed treatment to said physician via a text-to-speech conversion system coupled to said conference calling system, said a text-to-speech conversion program enabling transmission of items in said database as voice messages over said conference calling system;
transmitting audio signals of entries in said database of treatments and procedures by means selected from the group consisting of pre-stored audio files, pre-recorded audio files, spontaneous conversion of text files to audio signals, and any combination of these
authenticating users by providing a database of users authorized to access the system, said user database coupled to said treatments database;
providing a text-to-speech conversion server coupled to said web server, said text-to-speech conversion server providing said text-to-speech conversion system;
providing an authentication server coupled to said conference calling system and said user database, said authentication server authenticating users of the system;
providing a telephony exchange and conferencing system having user authentication capacity coupled to said text-to-speech conversion server, said telephony exchange providing said conference calling system; whereby
a first person can select one or more proposed treatments and/or one or more proposed procedures for a patient to create a proposed treatment set having one or more elements and said physician who is authorized to approve the individual elements of said treatment set can be informed of said individual elements by said conference calling system and said text-to-speech conversion system and can approve or disapprove individually each separate one of said individual elements.

37. A method for providing documented care and treatment for a patient as set forth in claim 36, further comprising:
said first person being healthcare professional selecting a desired treatment or other protocol, prescription, or equipment recommendation from said database:

38. A method for providing documented care and treatment for a patient as set forth in claim 36, further comprising:
said first and said physician being the same person.
